(19) United States
(12) Patent Application Publication
(10) Pub. No.: US 2009/0234912 A1
(43) Pub. Date: Sep. 17, 2009

(54) FILE TRANSFER VIA LOCAL SERVER

(75) Inventors: Tommy E. Perrine, Poway, CA (US); Sven E. Nielsen, San Diego, CA (US)

Correspondence Address: JOSHUA D. ISENBERG;JDI PATENT, 809 CORPORATE WAY, FREMONT, CA, 94539, US

(73) Assignee: Sony Computer Entertainment America Inc., Foster City, CA (US)

(21) Appl. No.: 12/050,088

(22) Filed: Mar. 17, 2008

(51) Int. Cl. G06F 15/16

(52) U.S. Cl. 709/203

(57) ABSTRACT

Embodiments of the present invention use a web browser on a client and a file transfer server to transfer files over a wide-area network (WAN). The files are transferred from the client to the server or vice versa. The server transfers the file to a remote server via the WAN. Because the file transfer over the WAN is server-based, the client can handle its end of the file transfer process using a conventional web browser without special file transfer software.

### FIELD OF THE INVENTION

This invention is related to file transfer and more particularly to efficient transfer of large (e.g., greater than 2 GB) files between disparate facilities connected by wide area network links.

### BACKGROUND OF THE INVENTION

E-mail has typically been used to send files of varying sizes; however, above 10 to 20 MB, it becomes a very inefficient mechanism for file transfer. Most e-mail software is designed to deal with small messages (on the order of 100 k or less) and does not take well to files larger than about 20 MB.

For larger files, mechanisms such as FTP, Aspera, DigiDelivery and others have come into use. However, these mechanisms all use a single “client-server” approach. That is, there is one server that is used as a common storage area for files, and many clients who send and retrieve files. To send a file from one user to another, user A uploads the file to the server, and user B connects to the server and then retrieves it. This works fine if both users have a fast, close connection to the server, but if one or both users are far away from the server or have low-bandwidth network links to the server, it becomes inefficient and slow. Additionally, while there are different methods for overcoming the problems with transmitting a file over long distances, often these require special software or some form of tuning of the client computer.

Additionally, all these methods require the user to maintain a file storage area on a server for the express purpose of sending large files to remote users. However, the file does not need to remain at the server after a remote user has retrieved a file.

On solution known as DigiDelivery attempts to solve this problem. However, this solution requires client software in order to send files between the client and server. Furthermore, this solution does not support transfer of files larger than 16 GB. Additionally, DigiDelivery is an “appliance” product that does not permit the server tweaking necessary to raise efficiency of a transfer across long distance network connections.

It is common for email users to send files containing audio or video content as attachments to email messages. Videos in high-definition formats, such as Blu-Ray, tend to be very large files (e.g., 50 to 200 gigabytes). People desiring to send such files to each other would prefer to send them in a format that is as easy to use. In addition, it would be desirable to send such files to any destination connected to a wide-area network, such as the Internet. However, it is difficult, and in many cases impossible, for existing end-to-end systems, such as email systems, to handle such large files.

It is within this context that embodiments of the invention arise.

### BRIEF DESCRIPTION OF THE DRAWINGS

The teachings of the present invention can be readily understood by considering the following detailed description in conjunction with the accompanying drawings, in which:

FIG. 1 is a schematic drawing of a computer network illustrating examples of file transfer according to an embodiment of the present invention.

FIG. 2 is a flow diagram illustrating examples of methods of file transfer according embodiments of the present invention.

FIG. 3 is a schematic drawing of a file transfer server configured to implement file transfer according to an embodiment of the present invention.

FIG. 4 is a schematic drawing of a client device configured to implement file transfer according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Embodiments of the present invention draw upon the idea of using a store-and-forward type mechanism that have certain features in common with other store-and-forward mechanisms, such as e-mail, UUCP transmission, or USEnet newsgroups. In embodiments of the present invention, a store-and-forward mechanism may be applied to transmission of large files instead of small chunks of text.

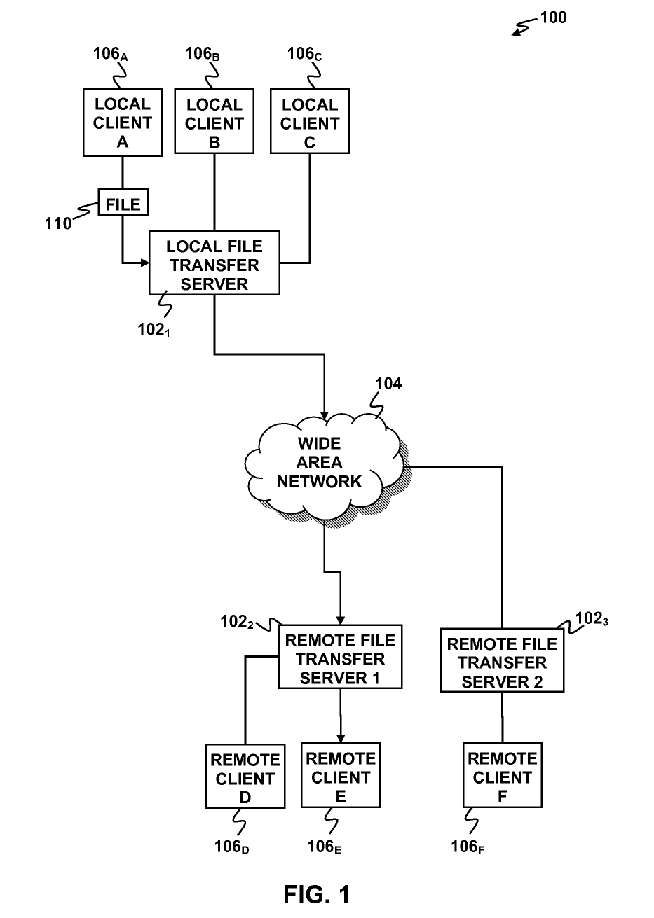

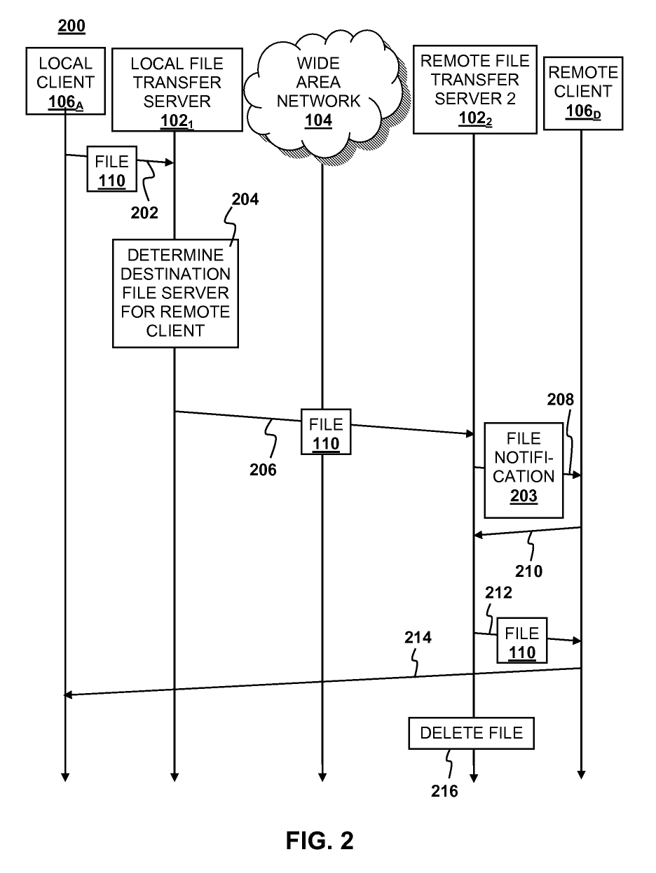

Embodiments of the present invention overcome the above-described disadvantages with the prior art by operating as described with respect to FIG. 1 and FIG. 2. As seen in FIG. 1, a file transfer system 100 according to an embodiment of the present invention may include one or more file transfer servers 102₁, 102₂, 102₃. Each file transfer server may be connected to one or more local clients. Each local file transfer server 102₁, 102₂, 102₃ may be connected to a wide area network (WAN) 104, such as the Internet. Each of the file transfer servers 102₁, 102₂, 102₃ may run at a site where there are users who might need to transfer files. Each user may have a client device that is coupled to one of the file transfer servers 102₁, 102₂, 102₃ e.g., via a local area network (LAN). By of example, and without loss of generality, three local client devices 106A, 106B, 106C may be coupled to a local file transfer server 102₁; two remote client devices 106D, 106E may be coupled to a first remote file transfer server 102₂ and another remote client device 106F may be coupled to a second remote file transfer server 102₃. In this way, each user may have access to a file transfer server that is LAN-local. Additional client devices may be added to the system 100 under the control of one of the file transfer servers 102, 102₂, 102₃.

The system shown in FIG. 1 may operate according to an inventive method to send a file 110 from one of the local clients to one of the remote clients or vice versa. For example, as shown in FIG. 2 the user of a first local client device 106A may wish to send a file to a second remote client device 106D. To send the file 110, the local client device 106A may connect to the local file transfer server 102₁ using a web browser. The user of the local client device 106A may choose a recipient for the file using the web browser. In general, the recipient is associated with one or more other client devices. However, the user need not know the location or network address of the client device. Instead, the name, user name or group name of the recipient may be sufficient. Once the recipient has been chosen the user may upload the file 110 to the local file transfer server 102₁ as indicated at 202. The local server 102₁ may generally determine remote file server(s) for remote client device(s) associated with recipient(s) of the file 110, as indicated at 204. The local server 102₁ may then transfer one copy of the file 110 to each remote file server as needed. In the particular example shown in FIG. 2, the recipient of the file 110 is associated with remote client 106D. In this example, remote file transfer server 102₂ is associated with remote client 106D. Therefore as indicated at 204 the local file transfer server 102₁ sends the file 110 to the remote file transfer server 102₂ via the wide area network 104.

Each intended recipient of the file 110 is then notified of the arrival of the file at the file transfer server for the recipient's client device and that the file is available for download. Again referring to the example in FIG. 2, the remote file transfer server 102₂ may send a notification 203 to the remote client 106D as indicated at 208. The notification 203 may be in any suitable form, e.g., email message, instant message, or other electronic notification. By way of example, the notification may include a link to a web page or other network location where a user may download the file 110. The user may send a request from the client device 106D to the remote server 102₂ to download the file as indicated at 210. To send the download request, the user may use a web browser to navigate to a link sent in the file notification 203. In one embodiment, the file notification 203 may include a link implemented, e.g., in hypertext markup language (HTML) or other suitable language and embedded directly into the text of the message. The user may navigate to the download location simply by clicking on the link. As indicated at 212, the remote file transfer server 102₂ may send the file to the client device 106D in response to the download request. Either the remote file transfer server 102₂ or the remote client device 106D may automatically notify the local client 102₁ that the file has been successfully downloaded as indicated at 214.

In some embodiments, the file 110 may remain on the remote server 102₂ for a specific length of time. Software running on the remote server may be configured to automatically delete the file after this time expires.

In certain embodiments, the local file transfer servers 102₁, 102₂ may be connected to their respective client devices 106A 106D relatively high-speed data links. The file transfer servers 102₁, 102₂ may be connected to each other by relatively low speed data links via the wide area network 104. Thus the file 110 may be uploaded to the local file transfer server 102₁ and downloaded from the remote file transfer server 102₂ very quickly, e.g. at several gigabits per second. This can greatly reduce the amount of time that the client devices spend in transferring the file since the slower portion of the file transfer is handled by the servers. This frees up the client devices for other tasks.

Furthermore, if a file is to be sent to multiple recipients affiliated with the same file transfer server only one copy of the file needs to be stored at the remote file transfer server. Each user recipient for the file can download a copy of the file to that user's client device.

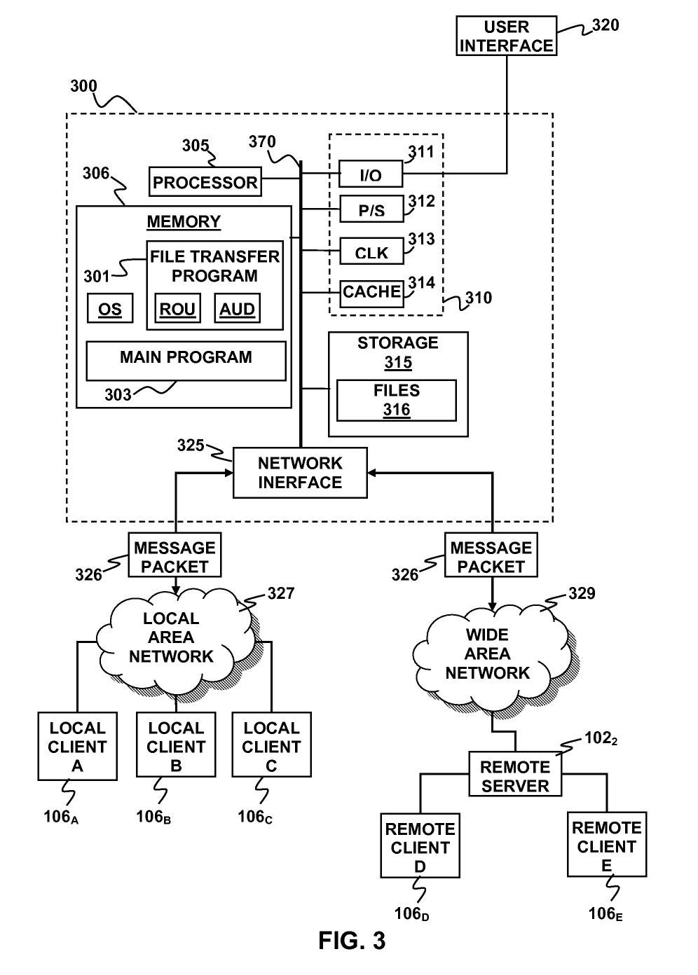

By way of example, the file transfer servers 102₁, 102₂, 102₃ may be configured as shown in FIG. 3, which depicts a block diagram illustrating the components of a file transfer server 300 according to an embodiment of the present invention. By way of example, and without loss of generality, the client device 300 may be implemented as a computer system, such as a personal computer, video game console, personal digital assistant, or other digital device, suitable for practicing an embodiment of the invention. The client device 300 may include a processor 305 configured to run software applications and optionally an operating system. The processor 305 may include one or more processing cores. By way of example and without limitation, the processor 305 may be a parallel processor module, such as a Cell Processor. An example of a Cell Processor architecture is described in detail, e.g., in Cell Broadband Engine Architecture, copyright International Business Machines Corporation, Sony Computer Entertainment Incorporated, Toshiba Corporation Aug. 8, 2005 a copy of which may be downloaded at http://cell.scei.co.jp/, the entire contents of which are incorporated herein by reference.

A memory 306 is coupled to the processor 305. The memory 306 may store applications and data for use by the processor 305. The memory 306 may be in the form of an integrated circuit, e.g., RAM, DRAM, ROM, and the like). The server 300 may also include well-known support functions 310, such as input/output (I/O) elements 311, power supplies (P/S) 312, a clock (CLK) 313 and cache 314. The client device 300 may further include a storage device 315 that provides non-volatile storage for applications and data. The storage device 315 may be used for temporary or long-term storage of files 316 that are to be transferred by the server 300. By way of example, the storage device 315 may be a fixed disk drive, removable disk drive, flash memory device, tape drive, CD-ROM, DVD-ROM, Blu-ray, HD-DVD, UMD, or other optical storage devices.

A user interface 320 may be used to communicate user inputs from one or more users to the server 300. By way of example, one or more of the user interface 320 may be coupled to the client device 300 via the I/O elements 311. Examples of suitable input devices that may be used as the interface 320 include keyboards, mice, joysticks, touch pads, touch screens, light pens, still or video cameras, and/or microphones or some combination of two or more of these. The server 300 may include a network interface 325 to facilitate communication via an electronic communications network 327. The network interface 325 may be configured to implement wired or wireless communication over local area networks and wide area networks such as the Internet. The server 300 may send and receive files and/or requests for files via one or more message packets 326 over a local area network 327 to one or more local clients 106A, 106B, 106C. The server 300 may similarly communicate with a remote server 102₂ coupled to remote clients 106D, 106E via a wide area network 329.

The components of the server 300, including the CPU 305, memory 306, support functions 310, data storage 315, user input devices 320, network interface 325, and audio processor 355 may be operably connected to each other via one or more data buses 370. These components may be implemented in hardware, software or firmware or some combination of two or more of these.

A server-side file transfer program 301 may be stored in the memory 306 in the form of instructions that can be executed on the processor 305. The instructions of the file transfer program 301 may be configured to implement, amongst other things, certain steps of a method for file, e.g., as described above with respect to FIG. 1 and FIG. 2. By way of example, the file transfer program 301 may include instructions to receive an outbound file bound from a first client to a second client, send the file to a second server over a wide-area network (WAN), receive a first notification from the second server, wherein the first notification indicates that the second client has downloaded the outbound file form the second server, and send a second notification to the first client. The second notification may indicate that the second client has downloaded the outbound file. Alternatively, the file transfer program 301 may include instructions to receive an inbound file from a remote server via a wide-area network (WAN); determine a local client coupled to the server that should receive the inbound file; send an availability notification to the local client, wherein the availability notification indicates that the inbound file is available at the server for download by the local client; send the inbound file to the local client upon request from the local client; and send a download notification to a remote client via the remote server, wherein the download notification indicates that the local client has downloaded the inbound file. Furthermore, the file transfer program 301 may include instructions for handling both inbound and outbound files.

The program 301 may be configured to operate in conjunction with other programs, such as an operating system OS. Furthermore, the file transfer program 301 may additionally operate in conjunction with one or more instructions configured to implement an interactive environment on remote client devices. By way of example, such instructions may be part of a main program 303, such as a video game program. Alternatively, the main program 303 may be a program for interfacing with a virtual world. The main program 303 may be configured to facilitate display of a scene of a portion of the simulated environment from the camera POV on a video display and change the scene as the camera POV changes in response to movement of the camera POV along a camera path during the user's interaction with the simulated environment. The main program 303 may include instructions for physics simulation, camera management and the like.

In addition, the file transfer program 301 may be configured with instructions to handle security at the server 300. For example, the program 301 may determine whether to encrypt one or more files based on a path between the server 300 and a destination for the file. Specifically, it may be desirable for security reasons to encrypt a file that is to be transferred over publicly accessible network, such as the Internet. The Memory 306 may include an encryption program ENC, which may be called by the file transfer program 301 and executed on the processor 305 to encrypt one or more files 316.

In addition, the server 300 may be configured to audit all inbound and outbound file transfer that it handles. Specifically, the file transfer program 301 may call upon an audit routine AUD that keeps track of which files were transferred, the time of transfer the duration of the transfer, the source and destination of the file, whether the file was received and other useful information relating to file transfer. In some cases, the file transfer program 301 may be configured to cancel or delete copies of one or more particular files from storage 315 before they are downloaded by a local client device.

In some embodiments the server 300 may be configured to determine which route to take based on factors, such as the time of day. Specifically, the file transfer program 301 may include a routing routine ROU that determines the time of day, e.g., from the clock, processes information related to network path behavior and determines which path to use based on the path behavior. By way of example, the routing routine ROU may determine from network data that particular network paths can use only 80% of their bandwidth during day but can use 100% of the bandwidth at night. The routing routine ROU may choose the higher capacity paths and avoid the lower capacity paths.

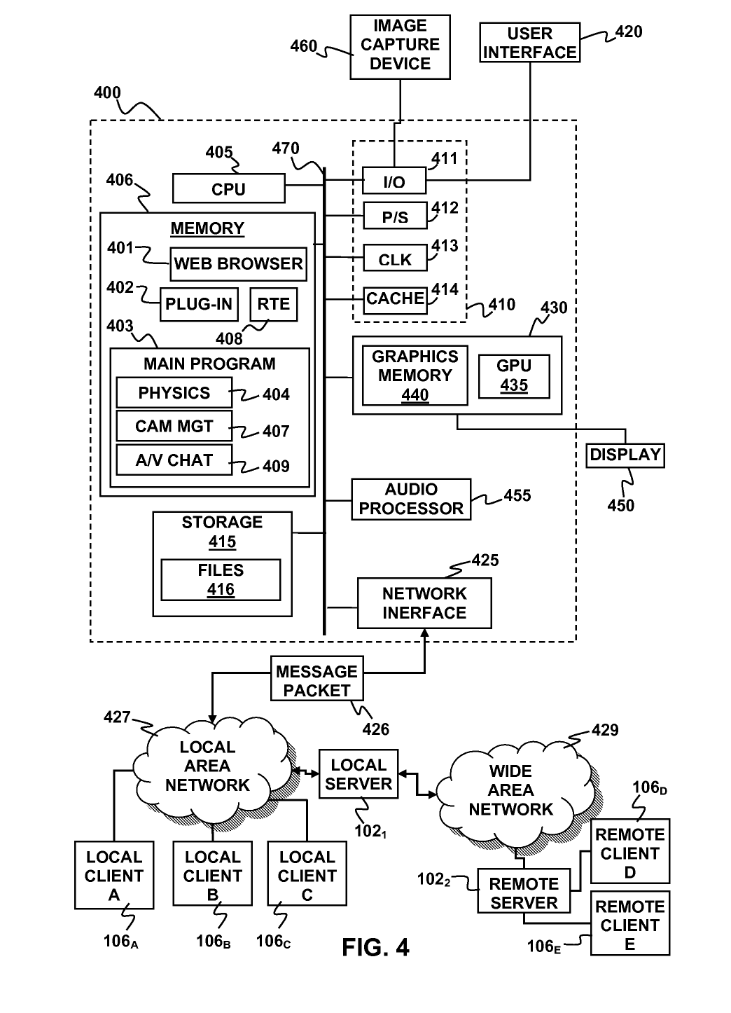

Embodiments of the present invention may be used for file transfer between any number of different types of client devices. By way of example, the client devices 106A, 106B, 106C, 106D, 106E may be configured as shown in FIG. 4, which depicts a block diagram illustrating the components of a client device 400 according to an embodiment of the present invention. By way of example, and without loss of generality, the client device 400 may be implemented as a computer system, such as a personal computer, video game console, personal digital assistant, or other digital device, suitable for practicing an embodiment of the invention. The client device 400 may include a central processing unit 405 configured to run software applications and optionally an operating system. The processing unit 405 may include one or more processing cores. By way of example and without limitation, the processing unit 405 may be a parallel processor module, such as a Cell Processor, e.g., as described above. A memory 406 is coupled to the processing unit 405. The memory 406 may store applications and data for use by the CPU 405. The memory 406 may be in the form of an integrated circuit, e.g., RAM, DRAM, ROM, and the like).

The client device 400 may also include well-known support functions 410, such as input/output (I/O) elements 411, power supplies (P/S) 412, a clock (CLK) 413 and cache 414. The client device 400 may further include a storage device 415 that provides non-volatile storage for applications and data. The storage device 415 may be used for temporary or long-term storage of auxiliary files 416 downloaded from a local file transfer server 102₁. By way of example, the storage device 415 may be a fixed disk drive, removable disk drive, flash memory device, tape drive, CD-ROM, DVD-ROM, Blu-ray, HD-DVD, UMD, or other optical storage devices.

The components of the client device 400, including the CPU 405, memory 406, support functions 410, data storage 415, user input devices 420, network interface 425, and audio processor 455 may be operably connected to each other via one or more data buses 470. These components may be implemented in hardware, software or firmware or some combination of two or more of these.

One or more user input devices 420 may be used to communicate user inputs from one or more users to the computer client device 400. By way of example, one or more of the user input devices 420 may be coupled to the client device 400 via the I/O elements 411. Examples of suitable input device 420 include keyboards, mice, joysticks, touch pads, touch screens, light pens, still or video cameras, digital cameras, and/or microphones. The client device 400 may include a network interface 425 to facilitate communication via an electronic communications network including a local area network (LAN) 427 and/or a wide area network (WAN) 429. The network interface 425 may be configured to implement wired or wireless communication over local area networks and wide area networks such as the Internet. The client device 400 may send and receive data and/or requests for files via one or more message packets 426 over the networks 427, 429.

A web browser program 401 may be stored in the memory 406 in the form of instructions that can be executed on the processor 405. Examples of commercially available web browsers include Netscape and Microsoft Internet Explorer. A plug-in 402 for a scripting language used by the web browser 401 and a runtime engine 408 for the scripting language may also be stored in memory and executed by the processing unit 405. The web browser program 401 may be used to facilitate, amongst other things, certain parts of a method for file transfer, e.g., as described above with respect to FIG. 1 and FIG. 2.

In particular, the web browser 401 may be used to facilitate transfer of outbound files from client device 400 to a remote client 106_{D} via one or more file transfer servers 102₁, 102₂ and the WAN 429. Specifically, the web browser 401 may be used to send a file 416 from the client device 400 to a local server 102₁, e.g., via the LAN 427; send information identifying the remote client 106_{D} to the local server 102₁; and receive a notification from a remote server 102₂ associated with the remote client 106_{D} indicating that the remote client 106_{D} has downloaded the file from the remote server 102₂. Furthermore, the web browser 401 may be used to facilitate transfer of inbound files from a remote client 106_{D} via one or more file transfer servers 102₁, 102₂ and the WAN 429. In particular, the web browser 401 may be used to receive a notification from the local server 102₁ indicating that a file 416 is available at the local server 102₁ for download by the client device 400; send a download request to the local server 102₁ indicating that the client device 400 is ready to download the file from the local server 102₁; and download the file from the local server 102₁ to the client device 400, e.g., to the memory 406 or storage 415. In certain embodiments, the client device 400 may implement these functions using only the web browser 401, the plug-in 402 and the runtime engine 408.

The web browser program 401 may operate in conjunction with one or more instructions configured to implement an interactive environment. By way of example, such instructions may be part of a main program 403, such as a video game program. Alternatively, the main program 403 may be a program for interfacing with a virtual world. The main program 403 may be configured to display a scene of a portion of the simulated environment from the camera POV on a video display and change the scene as the camera POV changes in response to movement of the camera POV along a camera path during the user's interaction with the simulated environment. The main program may include instructions for physics simulation 404, camera management 407 and audio-video chat 409. The main program 403 may call the impression enhancement program 401, physics simulation instructions 404, camera management instructions 407 and A/V chat 409, e.g., as a functions or subroutines.

The client device 400 may further comprise a graphics subsystem 430, which may include a graphics processing unit (GPU) 435 and graphics memory 440. The graphics memory 440 may include a display memory (e.g., a frame buffer) used for storing pixel data for each pixel of an output image. The graphics memory 440 may be integrated in the same device as the GPU 435, connected as a separate device with GPU 435, and/or implemented within the memory 406. Pixel data may be provided to the graphics memory 440 directly from the CPU 405. Alternatively, the processing unit 405 may provide the GPU 435 with data and/or instructions defining the desired output images, from which the GPU 435 may generate the pixel data of one or more output images. The data and/or instructions defining the desired output images may be stored in memory 410 and/or graphics memory 440. In an embodiment, the GPU 435 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 435 may further include one or more programmable execution units capable of executing shader programs.

The graphics subsystem 430 may periodically output pixel data for an image from the graphics memory 440 to be displayed on a video display device 450. The video display device 450 may be any device capable of displaying visual information in response to a signal from the client device 400, including CRT, LCD, plasma, and OLED displays. The computer client device 400 may provide the display device 450 with an analog or digital signal. By way of example, the display 450 may include a cathode ray tube (CRT) or flat panel screen that displays text, numerals, graphical symbols or images. In addition, the display 450 may include one or more audio speakers that produce audible or otherwise detectable sounds. To facilitate generation of such sounds, the client device 400 may further include an audio processor 455 adapted to generate analog or digital audio output from instructions and/or data provided by the processor 405, memory 406, and/or storage 415.

Although, for the purpose of example, client devices and file transfer servers are shown as being separate devices, embodiments of the present invention include the possibility that a client and server may be incorporated into the same device, e.g., in hardware, software, firmware or some combination of two or more of these.

Embodiments of the present have significant advantages over other existing mechanisms for transfer of large files. In particular embodiments of the present invention allow for browser-based client interactivity. No special software or software tuning is required on the client device other than a standard web browser that can speak a script language used by the server, such as ECMAscript/JavaScript along with a Runtime Engine and browser plug-in for the script language. Many client devices, especially personal computers, have these readily-available components already installed. Furthermore, embodiments of the present invention can handle very large files. It does not matter if the file in question is 100 k or 100 GB; the ability to transfer files is only limited by the amount of storage available to each file transfer server. With the proper amount of storage, embodiments of the present invention could conceivably handle 1-Terabyte files or larger files. In addition, file transfer in embodiments of the present invention is server-based. This allows optimization to handle large transfers quickly and efficiently to take place at the file transfer server. Transfers to and from client devices can occur with default settings on the client device.

Embodiments of the present invention may be used to facilitate peer-to-peer video mail, e.g., using a digital camera coupled to a client device. An example of a suitable camera is the Eye-Toy by Logitech International S.A. of Romanel-sur-Morges, Switzerland. Embodiments of the present invention may be used distribute wireless video voice mail using a game console device, such as PlayStation 3 from Sony Computer Electronics as a file transfer server and a handheld device as a local client. Examples of handheld devices that may be used as local clients include network-capable devices such as gaming devices (e.g., PlayStation Portable), cell phones, personal digital assistants, portable email devices or multi-function devices such as the Iphone from Apple.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for file transfer, comprising:
a) receiving a file bound from a first client to a second client at a first server;
b) determining a second server to which to send the file, wherein the second server is associated with the second client; and
c) sending the file from the first server to a second server over a wide-area network (WAN).

2. The method of claim 1, wherein a) includes receiving the file from the first client at the first server via a local area network (LAN).

3. The method of claim 1 wherein the file is sent from the first client to the first server and the second notification is sent from the first server to the first client by a local area network (LAN).

4. The method of claim 1 wherein b) includes determining whether the file needs to be encrypted based on the nature of the WAN before sending the file to the second server over the WAN.

5. The method of claim 1 wherein b) includes encrypting the file with the first server before sending the file to the second server over the WAN.

6. The method of claim 1 wherein a size of the file is greater than about 1 gigabyte.

7. The method of claim 6 wherein the size of the file is greater than about 50 gigabytes.

8. The method of claim 6 wherein the size of the file is between about 50 gigabytes and about 200 gigabytes.

9. The method of claim 1 wherein b) includes determining a best route between the first server and the second server based on a time of day.

10. The method of claim 1 wherein the first client and the first server are on the same device.

11. A method for file transfer, comprising:
a) receiving a file at a first server from a second server via a wide-area network (WAN);
b) determining with the first server a first client coupled to the first server that should receive the file;
c) sending a first notification from the first server to the first client, wherein the first notification indicates that the file is available at the first server;
d) sending the file from the first server to the first client upon request from the first client; and
e) sending a second notification from the first server to a second client via the second server, wherein the second notification indicates that the first client has downloaded the file.

12. The method of claim 11, wherein d) includes sending the file from the first server to the first client over a local area network (LAN).

13. The method of claim 11, wherein c) includes sending the first notification from the first client to the first server by a local area network (LAN).

14. The method of claim 11 wherein a), b) or d) includes determining whether the file needs to be decrypted.

15. The method of claim 11 wherein a), b) or d) includes decrypting the file before sending the file to the first client.

16. The method of claim 11 wherein a size of the file is greater than about 1 gigabyte.

17. The method of claim 16 wherein the size of the file is greater than about 50 gigabytes.

18. The method of claim 16 wherein the size of the file is between about 50 gigabytes and about 200 gigabytes.

19. The method of claim 11 wherein a) includes storing the file at a storage local to the first server for a predetermined period of time.

20. The method of claim 19, further comprising deleting the file from the storage after the predetermined period of time.

21. A server, comprising:
a processor;
a memory; and
processor-executable instructions stored in the memory and configured for execution on the processor, wherein the instructions are configured, when executed, to cause the server to:
A):
receive an outbound file bound from a first client to a second client,
send the file to a second server over a wide-area network (WAN),
receive a first notification from the second server, wherein the first notification indicates that the second client has downloaded the outbound file form the second server, and
send a second notification to the first client, wherein the second notification indicates that the second client has downloaded the outbound file; or
B):
receive an inbound file from a remote server via a wide-area network (WAN);
determine a local client coupled to the server that should receive the inbound file;
send an availability notification to the local client, wherein the availability notification indicates that the inbound file is available at the server for download by the local client;
send the inbound file to the local client upon request from the local client; and
send a download notification to a remote client via the remote server, wherein the download notification indicates that the local client has downloaded the inbound file; or
both A) and B).

22. The server of claim 21, wherein the server is configured to communicate with the first client or the local client over a local area network.

23. The server of claim 21 wherein the processor-executable instructions include one or more instructions that, when executed, cause the server to determine whether to outbound file needs to be encrypted or the inbound file needs to be decrypted.

24. The server of claim 21, wherein the processor-executable instructions include one or more instructions that, when executed, cause the server to encrypt the outbound file or decrypt the inbound file.

25. The server of claim 21, further comprising a file storage device coupled to the server, wherein the file storage device is configured to store one or more files of at least one gigabyte.

26. The server of claim 25 wherein the file storage device is configured to store one or more files of at least 50 gigabytes.

27. The server of claim 25 wherein the file storage device is configured to store one or more files of at least 200 gigabytes.

28. The server of claim 25 wherein the file storage device is configured to store one or more files of at least one terabyte.

29. A computer-readable medium having processor-executable instructions embodied therein, wherein the instructions are configured, when executed, to cause a server to:
A):
receive an outbound file bound from a first client to a second client,
send the file to a second server over a wide-area network (WAN),
receive a first notification from the second server, wherein the first notification indicates that the second client has downloaded the outbound file form the second server, and
send a second notification to the first client, wherein the second notification indicates that the second client has downloaded the outbound file; or
B):
receive an inbound file from a remote server via a wide-area network (WAN);
determine a local client coupled to the server that should receive the inbound file;
send an availability notification to the local client, wherein the availability notification indicates that the inbound file is available at the server for download by the local client;
send the inbound file to the local client upon request from the local client; and
send a download notification to a remote client via the remote server, wherein the download notification indicates that the local client has downloaded the inbound file; or
both A) and B).

30. A method for file transfer, comprising:
a) sending a file from a first client to a first server using a web browser on the first client;
b) sending information identifying a second client from the first client to the first server over the LAN using the web browser, wherein the file is bound from the first client to a second client via the first server and a wide area network (WAN);
c) receiving a notification from a second server associated with the second client at the first client via the first server using the web browser, wherein the first notification indicates that the second client has downloaded file from the second server.

31. The method of claim 30 wherein the first client performs a), b) and c) with only the web browser, a plug-in for a scripting language used by the web browser and a runtime engine for the scripting language.

32. A method for file transfer, comprising:
a) receiving a notification from a first server at a first client using a web browser on the first client, wherein the file is bound to the first client from a second client via the first server and a wide area network (WAN), wherein the notification indicates that the file is available at the first server for download by the first client;
b) sending a download request from the first client to the first server using the web browser on the first client, wherein the download request indicates that the first client is ready to download the file from the first server; and
c) downloading the file from the first server to the first client using the web browser on the first client.

33. The method of claim 31 wherein the first client performs a), b) and c) with only the web browser, a plug-in for a scripting language used by the web browser and a runtime engine for the scripting language.

34. A file transfer system, comprising:
a first server adapted to couple to a wide area network (WAN);
a second server adapted to coupled to the WAN;
wherein the first server includes
a processor;
a memory; and
processor-executable instructions stored in the memory and configured for execution on the processor, wherein the instructions are configured, when executed, to cause the first server to:
A):
receive an outbound file bound from a first client to a second client,
send the file to the second server over the WAN,
receive a first notification from the second server, wherein the first notification indicates that the second client has downloaded the outbound file from the second server, and
send a second notification to the first client, wherein the second notification indicates that the second client has downloaded the outbound file; or
B):
receive an inbound file from the second server via the WAN;
determine a local client coupled to the first server that should receive the inbound file;
send an availability notification to the local client, wherein the availability notification indicates that the inbound file is available at the first server for download by the local client;
send the inbound file to the local client upon request from the local client; and
send a download notification to a remote client via the second server, wherein the download notification indicates that the local client has downloaded the inbound file; or
both A) and B).
